(19) United States
(12) Patent Application Publication
(10) Pub. No.: US 2016/0161802 A1
(43) Pub. Date: Jun. 9, 2016

(54) BACKLIGHT UNIT

(71) Applicant: Samsung Display Co., Ltd., Yongin-City (KR)

(72) Inventors: Junghyun KWON, Seoul (KR); Seon-Tae YOON, Seoul (KR); Haeil PARK, Seoul (KR); Kwangkeun LEE, Osan-si (KR)

(21) Appl. No.: 14/718,943

(22) Filed: May 21, 2015

(30) Foreign Application Priority Data
Dec. 5, 2014 (KR) 10-2014-0173905

(51) Int. Cl. G02F 1/1335

(52) U.S. Cl. CPC G02F 1/133608; G02F 1/133603; G02F 1/133605; G02F 1/133606

(57) ABSTRACT

A backlight unit includes a substrate having a plurality of block regions, partitions confining the block regions respectively on the substrate, patterns extending along a direction on surfaces of the partitions and being parallel with each other, and light sources disposed respectively in the block regions.

### CLAIM OF PRIORITY

A claim for priority under 35 U.S.C. §119 is made based on Korean Patent Application No. 10-2014-0173905 filed Dec. 5, 2014 in the Korean Intellectual Property Office, the entire contents of which are hereby incorporated by reference.

### BACKGROUND OF THE INVENTION

The present invention described herein relates to a backlight unit, and more particularly, relates to a direct backlight unit.

A liquid crystal display is a kind of flat panel display most widely used nowadays, for expressing images through a display panel made of a liquid crystal layer interposed between a pair of substrates in which electrodes are embedded. As the display panel does not have a self-luminous property, it needs a backlight unit to supply light thereto.

Based on positions of light source blocks, the backlight unit can be classified into edge and direct types. The light source block is usually placed at a side of the back of the display panel in the edge type, but it is placed at the back of the display panel in the direct type.

Meanwhile, a variety of standpoints have being endeavored to develop local dimming technology that selectively changes brightness in required ones among a plurality of areas in order to reduce power consumption.

However, as partitions are employed to prevent light, which is emitted from such a direct backlight unit, from being diffused out of a light source block, there could be generated problems with dark sites and crosstalk which degrade luminescence of the liquid crystal display.

### SUMMARY OF THE INVENTION

One aspect of embodiments of the present invention is directed to providing a backlight unit improved in light extraction efficiency.

Technical aspects according to the present invention may not be restricted to those mentioned below, but rather incidentally other aspects will be noticed and simply understood by those skilled in the art without diligence.

In an embodiment, a backlight unit may include: a substrate having a plurality of block regions; partitions configured to confine the block regions respectively on the substrate; patterns extending along a direction on surfaces of the partitions and being parallel to each other; and light sources disposed respectively in the block regions.

In an embodiment, the patterns may protrude respectively from the surfaces of the partitions.

In another embodiment, the patterns may be concaved respectively from the surfaces of the partitions.

In still another embodiment, the patterns may have triangular sections with an inner angle of about 30° to 60°.

In still another embodiment, the patterns formed on the surface of at least one of the partitions may extend in parallel with a surface of the substrate.

In still another embodiment, the patterns formed on the surface of at least one of the partitions may extend vertically relative to a surface of the substrate.

In still another embodiment, the patterns formed on the surface of at least one of the partitions may extend at a slant relative to a surface of the substrate.

In still another embodiment, the patterns formed on two adjacent partitions may be connected to each other.

In still another embodiment, the patterns formed on two adjacent partitions may be alternately arranged relative to each other.

In still another embodiment, the patterns contain a reflective material so as to reflect light that may be emitted from the light sources

In still another embodiment, the backlight unit may further include a diffusion plate disposed on the partitions, wherein heights of the partitions may be 0.8 times a height between the substrate and the diffusion plate.

### BRIEF DESCRIPTION OF THE FIGURES

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a functional block diagram illustrating a display device according to an embodiment of the present invention;

FIG. 2 is a conceptual view illustrating a behavior of the display device shown in FIG. 1;

FIGS. 3A and 3B illustrate the mechanisms of implementing full colors under time/space division modes;

FIG. 4 is a plan view illustrating the backlight unit of the display device of FIG. 1;

FIG. 5 illustrates lighting points with respect to blocks relative to time;

FIG. 6 is a perspective view illustrating a backlight unit according to an embodiment of the present invention;

FIG. 7 is a sectional view illustrating a backlight unit according to an embodiment of the present invention;

FIGS. 8A and 8B are perspective views partly illustrating structures of partitions set in the backlight unit according to embodiments of the present invention;

FIGS. 9A through 9F are perspective views illustrating structures of the patterns set in the backlight unit according to embodiments of the present invention;

FIG. 10 is a functional block diagram illustrating a display device according to another embodiment of the present invention;

FIG. 11 is a plan view illustrating the correspondence between the backlight unit and the display panel shown in FIG. 10;

FIG. 12A shows a simulation result for a spectrum of light scattered and reflected in a general backlight unit without patterns in partitions thereof; and

FIG. 12B shows a simulation result for a spectrum of light scattered and reflected in a backlight unit with patterns in partitions thereof in accordance with an embodiment of the present invention.

### DETAILED DESCRIPTION

Embodiments will be described in detail with reference to the accompanying drawings. The present invention, however, may be embodied in various different forms, and should not be construed as being limited only to the illustrated embodiments. Rather, these embodiments are provided as examples so that this disclosure will be thorough and complete, and will fully convey the concept of the present invention to those skilled in the art. Accordingly, known processes, elements, and techniques are not described with respect to some of the embodiments of the present invention. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that, when a layer is referred to as being “between” two layers, it can be the only layer between the two layers, or one or more intervening layers may also be present.

The terminology used herein is for the purpose of describing particular embodiments only, and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that, when an element or layer is referred to as being “on”, “connected to”, “coupled to”, or “adjacent to” another element or layer, it can be directly on, connected to, coupled to, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art with respect to which the present invention belongs. It will be further understood that terms, such as those defined in commonly used dictionaries, should be interpreted as having a meaning that is consistent with their meaning in the context of the relevant art and/or the present specification, and will not be interpreted in an idealized or overly formal sense unless expressly so defined herein.

Exemplary embodiments of the present invention will now be described in conjunction with the accompanying drawings.

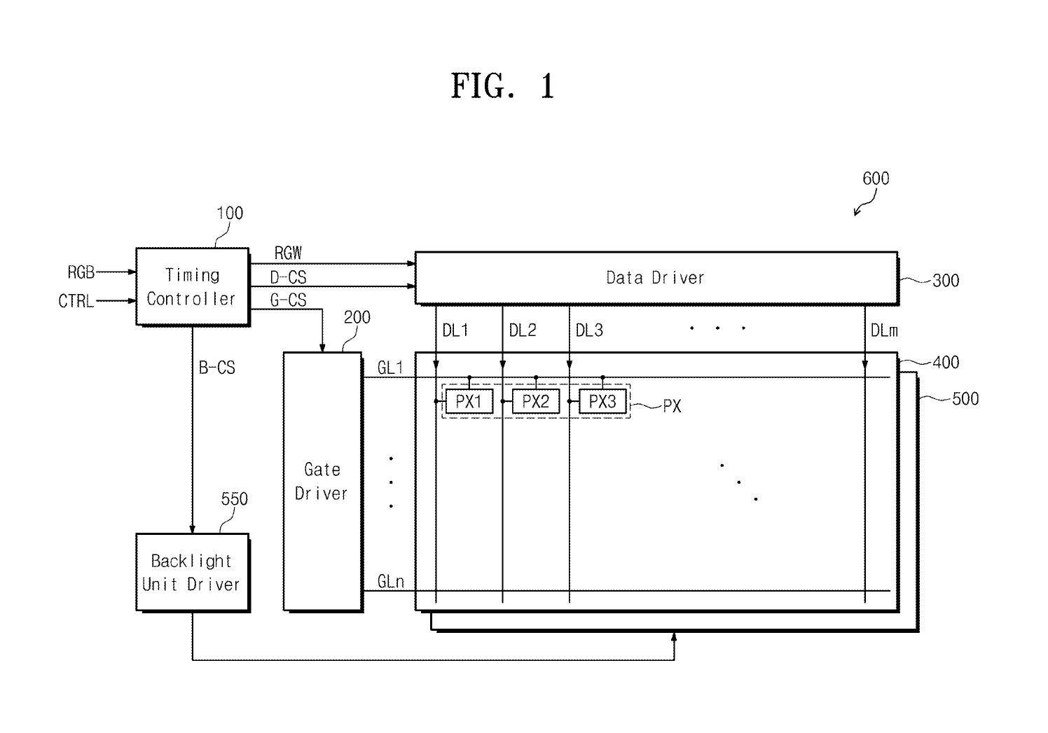

FIG. 1 is a functional block diagram illustrating a display device according to an embodiment of the present invention.

Referring to FIG. 1, the display device 600 includes a display panel 400, a panel driver activating the display panel 400, a backlight unit 500, and a backlight unit driver 550 activating the backlight unit 500. In this embodiment, the panel driver includes a gate driver 200, a data driver 300, and a timing controller 100 to control an operation of the data driver 300.

The display panel 400 includes a plurality of gate lines GL1˜GLn, a plurality of data lines DL1˜DLn, and a plurality of pixels. The data lines DL1˜DLn are arranged in parallel with each other along the column direction, and extending in the row direction. The gate lines GL1˜GLn are arranged in parallel with each other along the row direction, and extending in the column direction.

Each of the pixels PX includes first to third subpixels PX1, PX2 and PX3, and each of the first through third subpixels PX1˜PX3 includes a thin film transistor (not shown) and a liquid crystal capacitor (not shown).

The timing controller 100 receives image signals RGB and a plurality of control signals CTRL from a source external to the display device 600. The timing controller 100 renders and converts the image signals RGB into image signals RGW for interface specifications with the data driver 300. The converted image signals RGW are supplied to the data driver 300. Additionally, the timing controller 100 generates data control signals D-CS (e.g. an output start signal, a horizontal start signal, etc.), and gate control signals G-CS (e.g. a vertical start signal, a vertical clock signal, and a vertical clock bar signal) from the plural control signals CTRL. The data control signals D-CS are applied to the data driver 300 while the gate control signals G-CS are applied to the gate driver 200.

The gate driver 200 outputs gate signals sequentially in response to the gate control signals G-CS applied from the timing controller 400. Therefore, the plural pixels PX can be sequentially scanned by the gate signals in the unit of row.

The data driver 300 converts the image signals RGW into data voltages in response to the data control signals D-CS applied from the timing controller 100. The data voltages outputted from the data driver 300 are supplied to the display panel 400.

Accordingly, each pixel PX is turned on by the gate signal. The pixel PX turned on receives its corresponding data voltage so as to display an image with a desired gray scale.

As illustrated in FIG. 1, the backlight unit 500 is disposed at the rear of the backlight unit 500. Then, the backlight unit 500 supplies light at the rear side of the backlight light 500. The backlight unit driver 550 receives a light source control signal B-CS from the timing controller 100 and drives the backlight unit 500 in sync with the display panel 400.

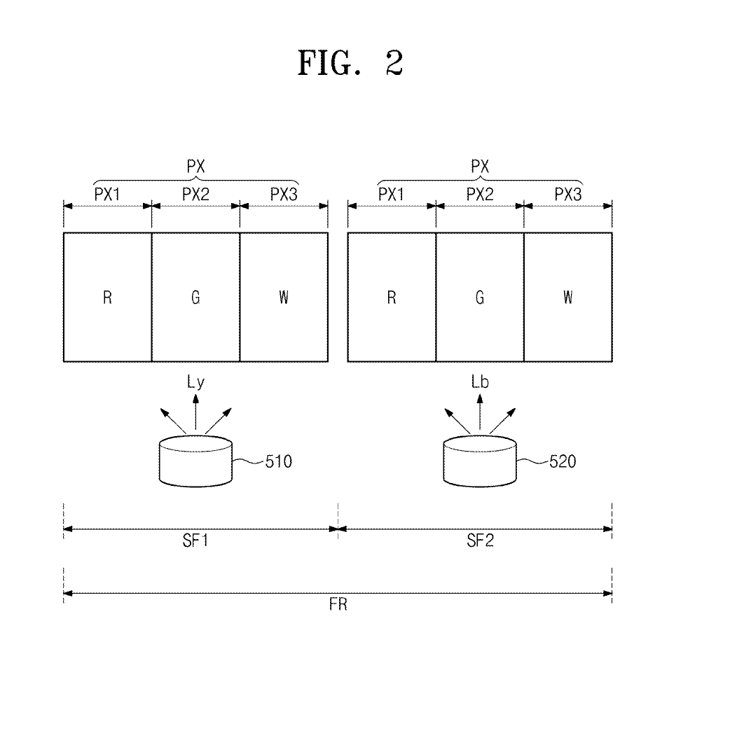

FIG. 2 is a conceptual view illustrating a behavior of the display device shown in FIG. 1.

Referring to FIG. 2, each pixel PX of the display panel 400 includes a first subpixel PX1 with a first principal color, a second subpixel PX2 with a second principal color, and a third subpixel PX3 with white.

In this embodiment, the first principal color is red and the first subpixel PX1 may include a red color filter R. The second principal color is green and the second subpixel PX2 may include a green color filter G. The third subpixel PX3 may include a white color filter W or an empty space where any color filter is not formed.

In this embodiment, the backlight unit 500 includes first light sources and second light sources. The backlight unit 500 generates and supplies light to the display panel 100. The first light source 510 emits light of a composite color with the first and second principal colors. In this embodiment, the first principal color is red, the second principal color is green, and the composite color is yellow.

The second light source 520 emits light of the third principal color. The third principal color may be blue. The first, second and third principal colors are mixed to show white. Although this embodiment is practiced with the first, second and third principal colors being red, green and blue, respectively, the present invention should not be restrictive thereto.

In embodiments of the present invention, the first light source 510 may be a light emission diode (LED) emanating yellow light Ly. The second light source 520 may be an LED emanating blue light Lb. Different from the illustrations, the first and second light sources 510 and 520, respectively, may be formed in a single package.

In this embodiment, the backlight unit 500 may be structured as a direct type where a plurality of light sources is included in the whole area of the bottom surface of the display panel 400. In another embodiment, the backlight unit 500 may be further equipped with a light guiding plate (not shown), thereby forming an edge-type structure wherein the first and second light sources are disposed at a side of the light guiding plate.

The backlight unit driver 550 of FIG. 1 operates to drive the backlight unit 500. The backlight unit driver 550 alternately may turn on the first and second light sources 510 and 520, respectively, on in the interval of one frame. If the display panel is designed to output images in 120 Hz, the backlight unit driver 550 may alternately turn the first and second light sources 510 and 520, respectively, on in the period of 120 Hz, 180 Hz, or 240 Hz.

One frame FR may include first and second subframes SF1 and SF2, respectively, and the first and second light sources 510 and 520, respectively, may be lightened for different respective subframes. For instance, in the first subframe SF1, the first light source 510 is turned on while the second light source 520 is turned off. In the second subframe SF2, the first light source 510 is turned off while the second light source 520 is turned on.

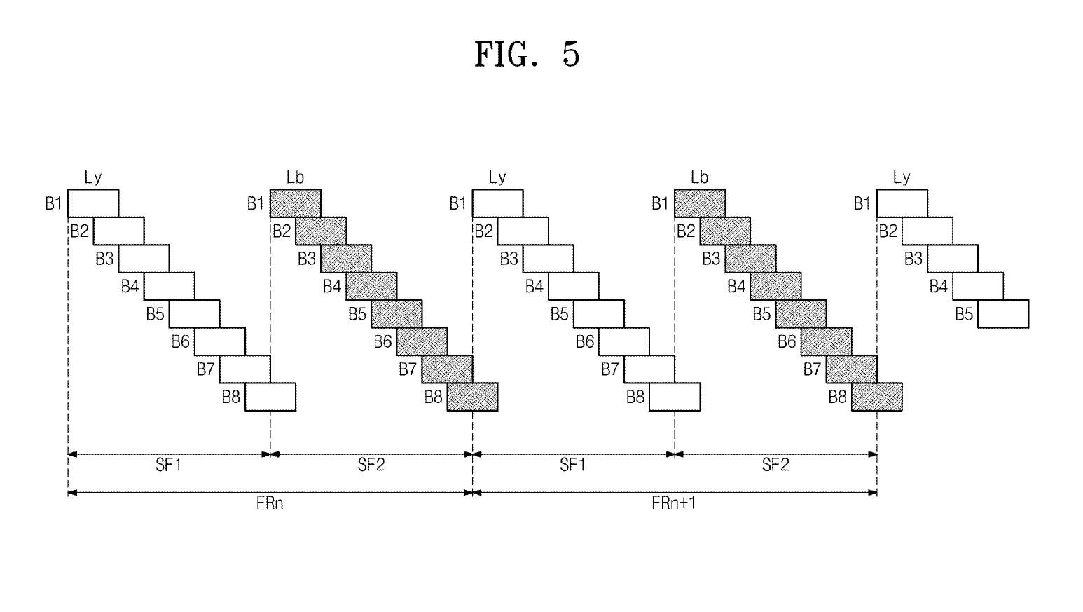

A lighting order of the first and second light sources 510 and 520, respectively, is modified in the unit of one frame FR. This will be detailed with reference to FIG. 5.

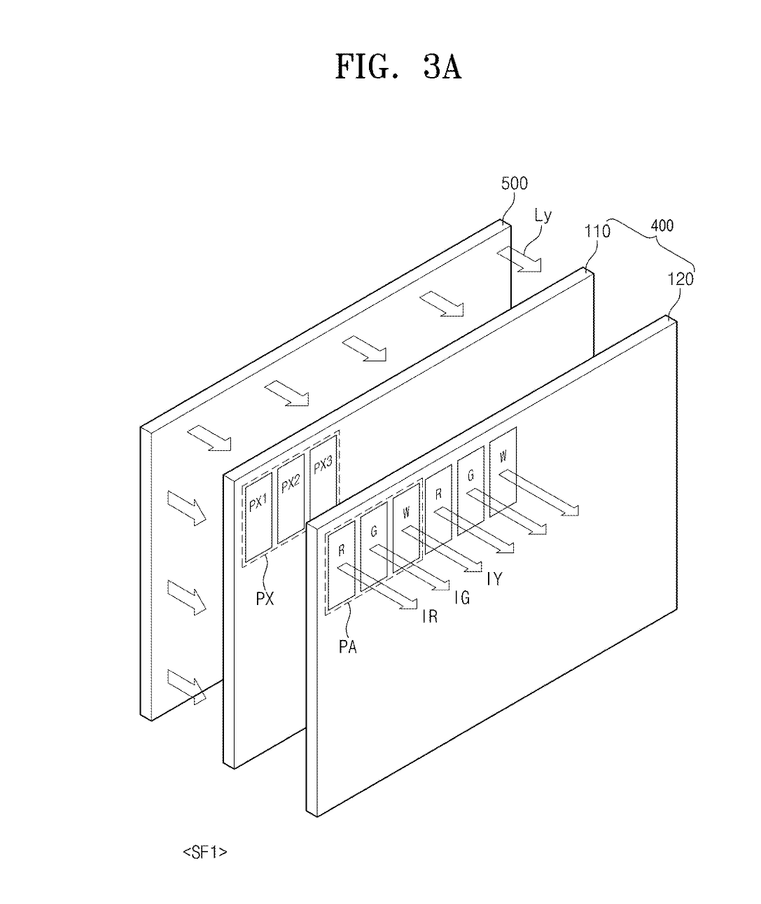

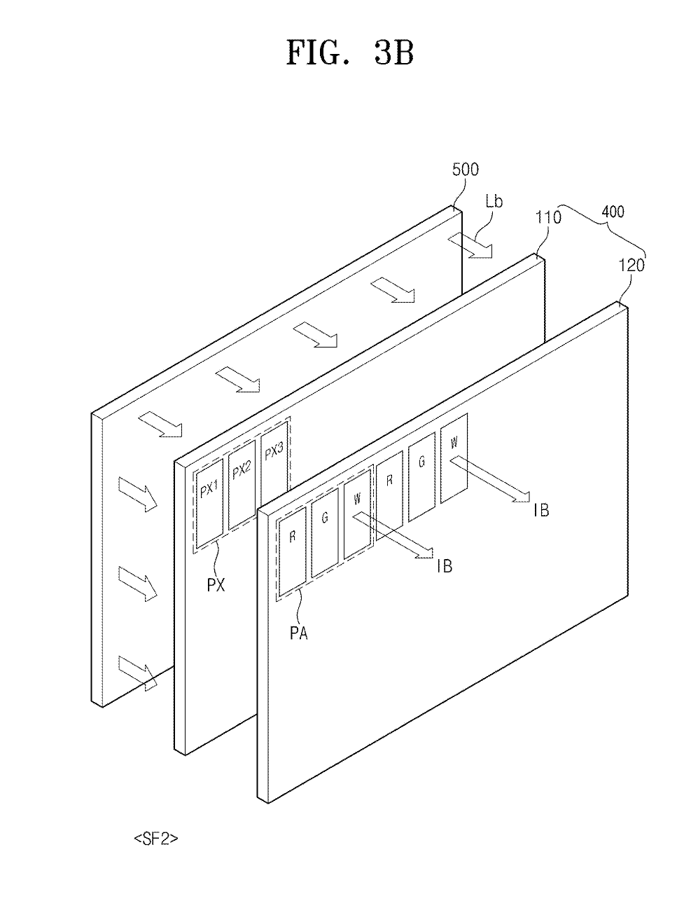

FIGS. 3A and 3B illustrate the mechanisms of implementing full colors under time/space division modes. FIG. 3A shoes an operation mode of the first subframe for one frame, and FIG. 3B shows an operation mode of the second subframe for one frame.

Referring to FIG. 3A, the display panel 400 includes a first substrate 110, a second substrate 120 parallel to the first substrate 110, and a liquid crystal layer (not shown) between the first and second substrates 110 and 120, respectively.

Although not shown, the first substrate 110 may act as a lower one having the first through third pixels PX1˜PX3. The second substrate 120 may act as an upper one having at least two color filters R and G in each pixel area PA corresponding to each pixel PX.

The color filters R and G may be formed in one of the first and second substrates 110 and 120, respectively.

In the interval of the first subframe SF1, the first light source 510 of FIG. 2 is turned on while the second light source 520 of FIG. 2 is turned off. Therefore, for the interval of the first subframe SF1, a red component of the yellow light Ly emitted from the first light source 510 is turned to a red image IR after passing through the first subpixel PX1 and the red color filter R, and a green component of the yellow light Ly is turned to a green image IG after passing through the second subpixel PX2 and the green color filer G. Additionally, the yellow light Ly is turned to a yellow image IY after passing through the third subpixel PX3. During this, in the interval of the first subframe SF1, the red, green and yellow images IR, IG and IY are displayed.

Next, referring to FIG. 3B, during the interval of the second subframe SF2, the second light source 120 may be turned on while the first light source 110 may be turned off. Then during the interval of the second subframe SF2, the blue light Lb emitted from the second light source 120 is turned to a blur image IB after passing through the third subpixel PX3. As the blue light Lb is disallowed to pass through the first and second subpixels PX1 and PX2, respectively, there is no emergence of the blue image IB through the first and second subpixels PX1 and PX2. During the interval of the second subframe SF2, a second image consisting of the blue image IB is displayed.

Accordingly, a user is able to visually recognize an intact image mixed with the first and second images at the end of one frame.

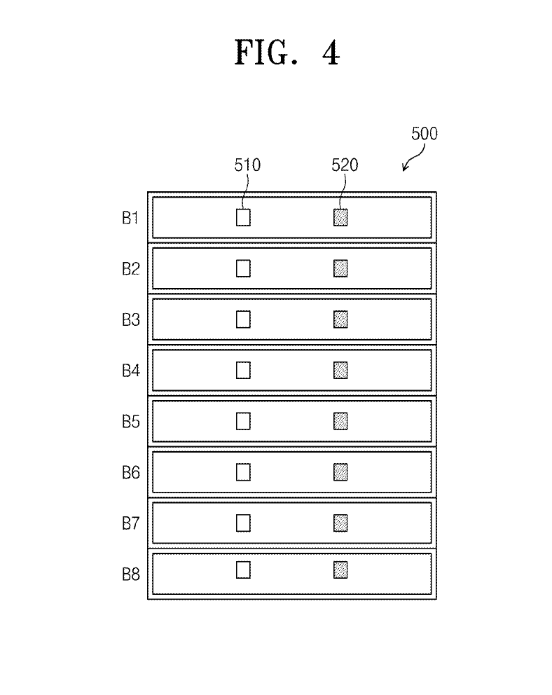

FIG. 4 is a plan view illustrating the backlight unit of the display device of FIG. 1, and FIG. 5 illustrates lighting points with respect to blocks relative to time.

Referring to FIG. 4, the backlight unit 500 may be structured in the direct type. The first and second light sources 510 and 520, respectively, are disposed in a single block. The first light source 510 includes yellow light emission diodes (LEDs) and the second light source 520 includes blue LEDs. The yellow LEDs may be driven independently of each other and the blue LEDs may be driven independently of each other.

The yellow LEDs may be sequentially turned on in the interval of their corresponding subframe and the plural blue LEDs may also be sequentially turned on in the interval of their corresponding subframe.

The substrate 505 of the backlight 500 may include a plurality of emission blocks B1˜B8. As an example, each of the emission blocks B1˜B8 may be comprised of one yellow LED and one blue LED, and may alternately output the yellow and blue light every frame. The number of the emission blocks may not be restrictive to that shown in FIG. 4.

As illustrated in FIG. 5, each of the successive frames includes the first and second frames SF1 and SF2, respectively. In an n'th frame FRn (n is a positive integer) of the plural frames, the first light source 510 is turned on for the interval of the first subframe SF1 while the second light source 520 is turned on for the interval of the second frame F2.

In the interval of the first subframe SF1 of the n'th frame FRn, the plural emission blocks B1˜B8 may emanate the yellow light Ly in sequence, for which adjacent ones of the emission blocks B1˜B8 may be partly overlapped in part with respect to each other in the emission period. In the interval of the second subframe SF2 of the n'th frame FRn, the plural emission blocks B1˜B8 may emanate the blue light Lb in sequence, for which adjacent ones of the emission blocks B1˜B8 may be partly overlapped in part with respect to each other in the emission period.

In an [n+1]'th frame FRn+1 in the plural frames, the second light source 520 is turned on for the interval of the first subframe SF1 while the first light source 510 is turned on for the interval of the second frame F2.

Accordingly, in the interval of the first subframe SF1 of the [n+1]'th frame FRn+1, the plural emission blocks B1˜B8 emanate the blue light Lb in sequence. In the interval of the second subframe SF2 of the [n+1]'th frame FRn, the plural emission blocks B1˜B8 emanate the yellow light Lb in sequence.

In the display device 600, as for one pixel, when the first light source 510 is turned on to emit the yellow light, a falling time of liquid crystals at a turning-off time of the second light source 520 becomes later so as to cause a phenomenon of color mingling or crosstalk. Additionally, with regard to white luminance of the third subpixel, color desaturation occurs due to the first subpixel PA1 including the red color filter and the second subpixel PX2 including the green color filter. Sequentially driving the first and second subframes SF1 and SF2, respectively, may cause a color breakup effect, by which a picture is partly separated into a component of primary color, when an observer rapidly moves his eyes or shortly intermits his view.

In order to resolve problems such as color mingling, crosstalk, color desaturation, color breakup, and so on, it may be available to use the display device 600 employing the backlight unit 500 configured according to embodiments of the present invention.

Further detailed description will follow relative to the backlight unit 500.

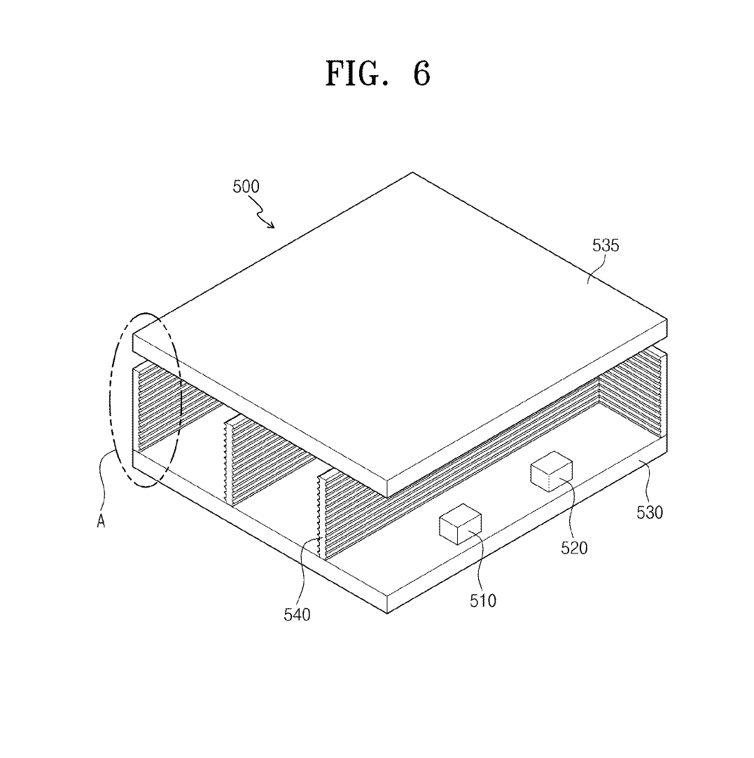

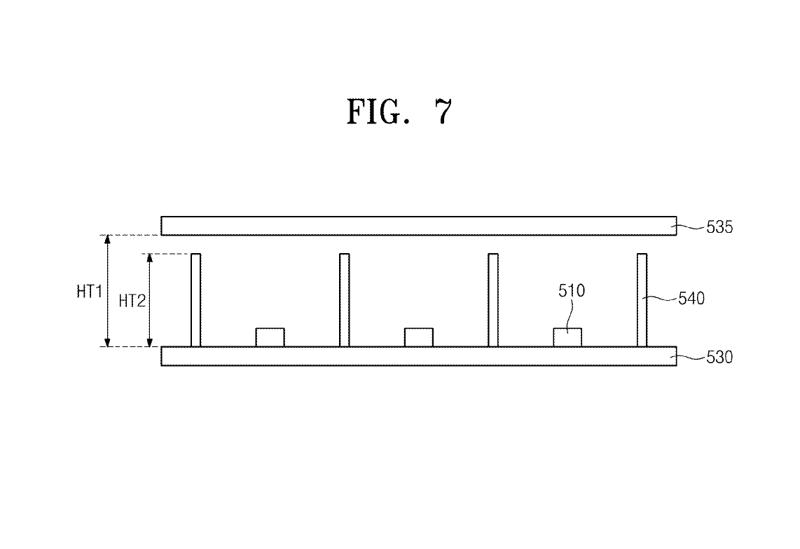

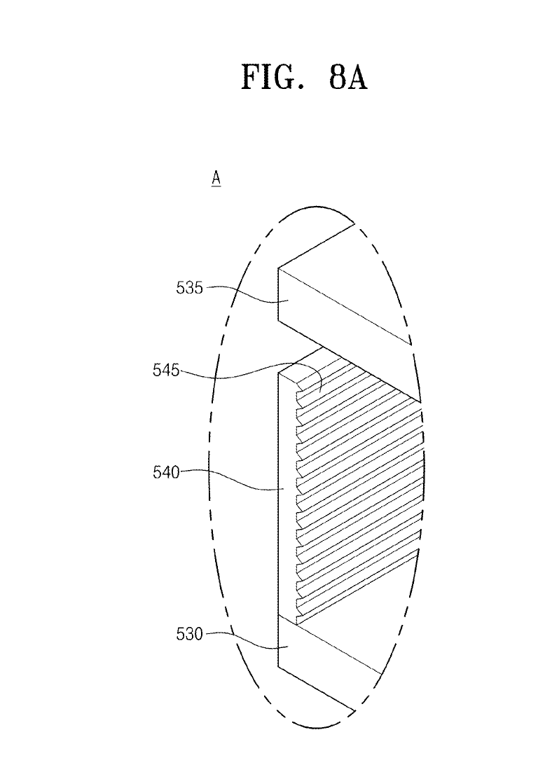

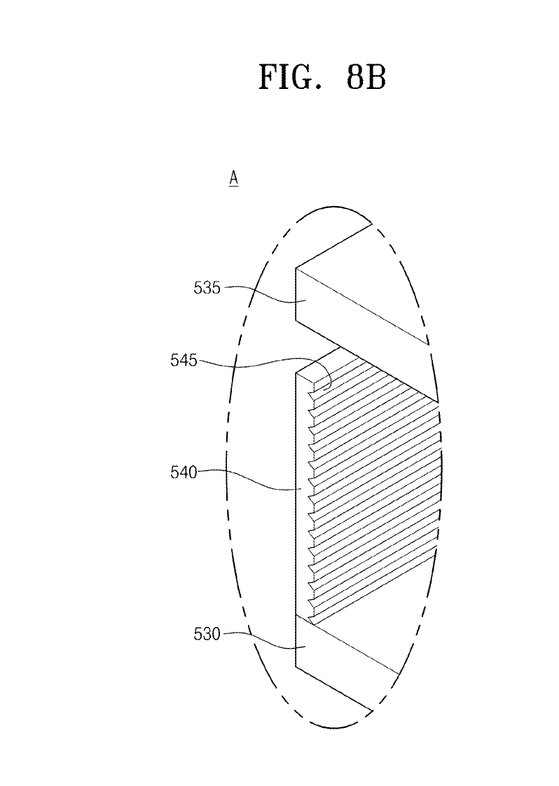

FIG. 6 is a perspective view illustrating a backlight unit according to an embodiment of the present invention, FIG. 7 is a sectional view illustrating a backlight unit according to an embodiment of the present invention, and FIGS. 8A and 8B are perspective views illustrating structures of partitions set in the backlight unit according to embodiments of the present invention (corresponding to a part A of FIG. 6).

Referring to FIGS. 6 and 7, the backlight unit 500 includes a substrate 530, a diffusion plate 535 separately opposing the substrate 530, light sources 510 and 520 interposed between the substrate 530 and the diffusion plate 535, and partitions 540 confining the substrate 530 to a plurality of block regions between the substrate 530 and the diffusion plate 535.

The substrate 530 may contain a reflective material. For example, the surface of the substrate 530 may be adhered to a reflective sheet or coated with a reflective material. The light sources 510 and 520 may be respectively disposed on the substrate 530, each employing an LED. The diffusion plate 535 may function to diffuse and transmit light, which is incident from the light sources 510 and 520, so as to cause uniform light.

The partitions 540 confine the plural block regions on the substrate 530. One block region is confined by four partitions 540. In one of the block region, at least one of the light sources 510 or 520 is settled. In this embodiment, such one block region is designed to accommodate two of the light sources 510 and 520. As aforementioned, these two light sources 510 and 520 include yellow and blue LEDs, respectively.

Heights H2 of the partitions 540 may be 0.8 times a height H1 between the substrate 530 and the diffusion plate 535. One end of the partitions 540 may contact the surface of the substrate 530, whereas the other end may be spaced by a determined distance from the diffusion plate 535 without contacting it. If the height H2 of the partitions 540 is larger than about 0.8 times the height H1 between the substrate 530 and the diffusion plate 535, dark sites are generated between adjacent block regions. Those dark sites are visually recognized as spots. Otherwise, if the height H2 of the partitions 540 is lower than about 0.8 times the height H1 between the substrate 530 and the diffusion plate 535, crosstalk becomes more present between adjacent block regions. The generation of dark sites and crosstalk due to the partitions 540 may cause problems such as color mingling, color desaturation, and color breakup.

The partitions 540 may contain a reflective material. According to an aspect of the present invention, the surfaces of the partitions 540 may be adhered to reflective sheets or coated with a reflective material. In embodiments of the present invention, patterns 545 of FIGS. 8A and 8B may be formed on the surface of at least one partition 540, which confines the one block region 540, in order to increase the reflection efficiency thereof.

The patterns 545 may be shaped in lines extending directionally. According to FIG. 8A, the patterns 545 may protrude from the surfaces of the partitions 540. According to another illustration in FIG. 8B, the partitions 540 may be concave from the surfaces of the partitions 540. Additionally, the patterns 545 may have triangular sections, respectively. An inner angle of such a triangular section may be 30° to 60°.

The patterns 545 may be variously shaped. Hereinafter the structure of the patterns 545 will be described in more detail, but the invention is not restricted thereto.

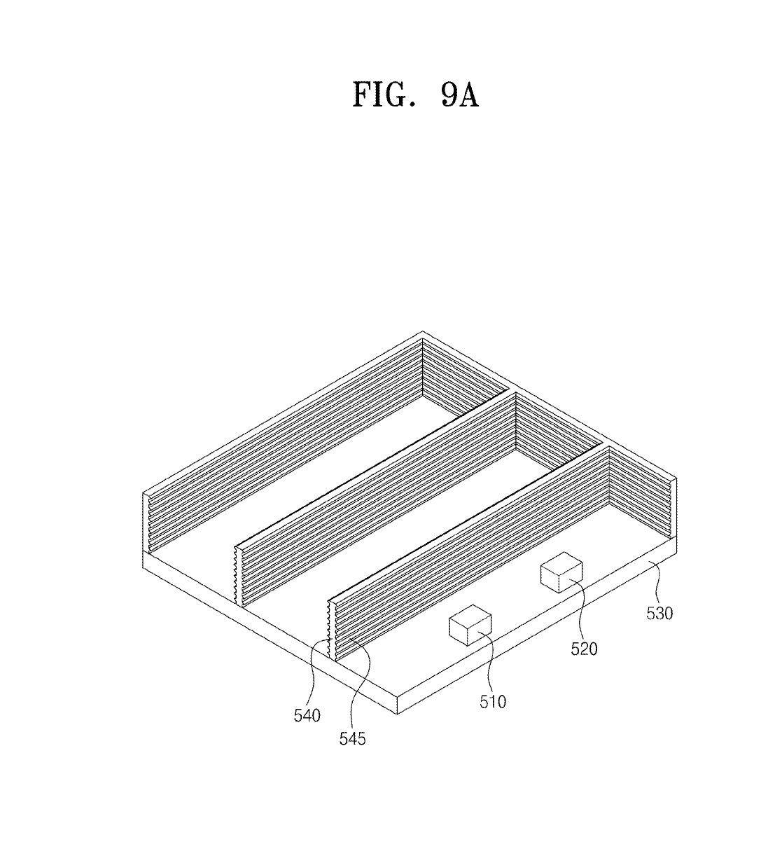

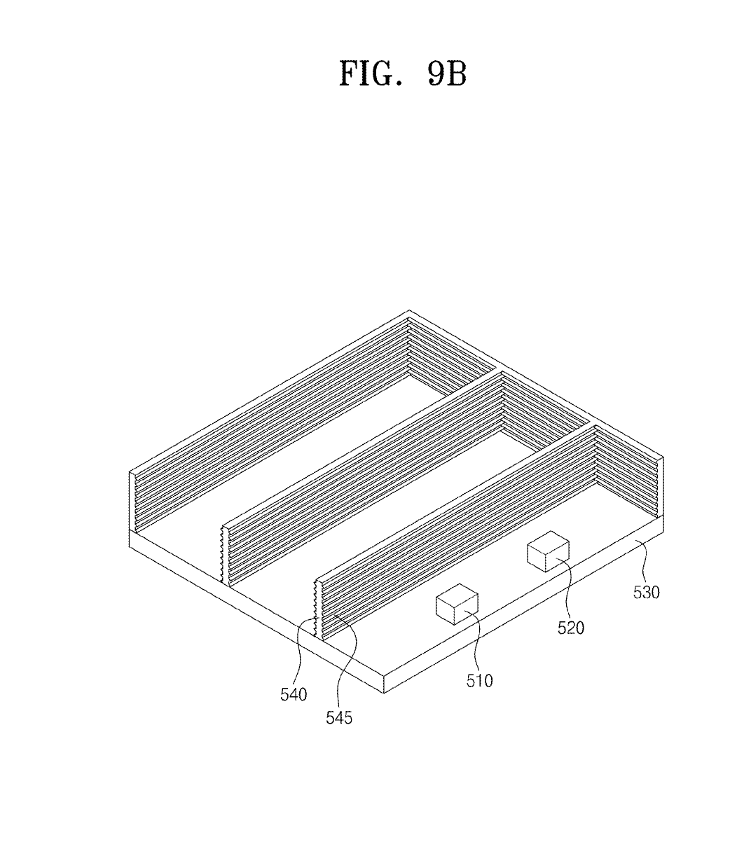

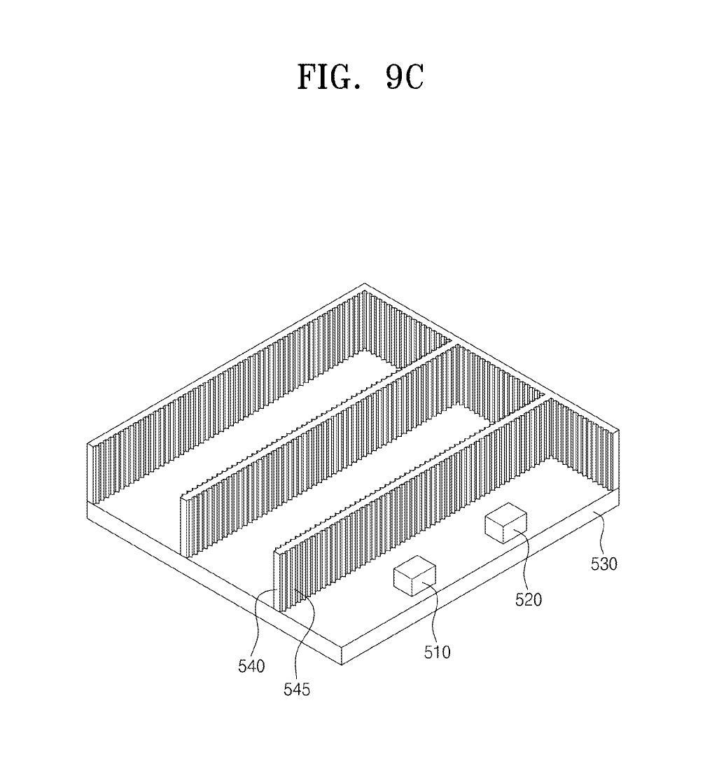

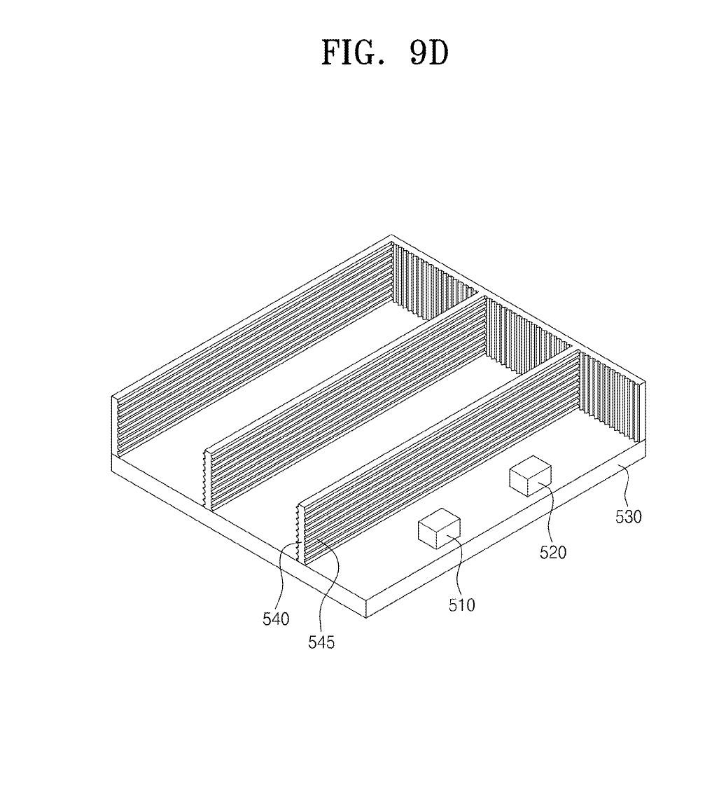

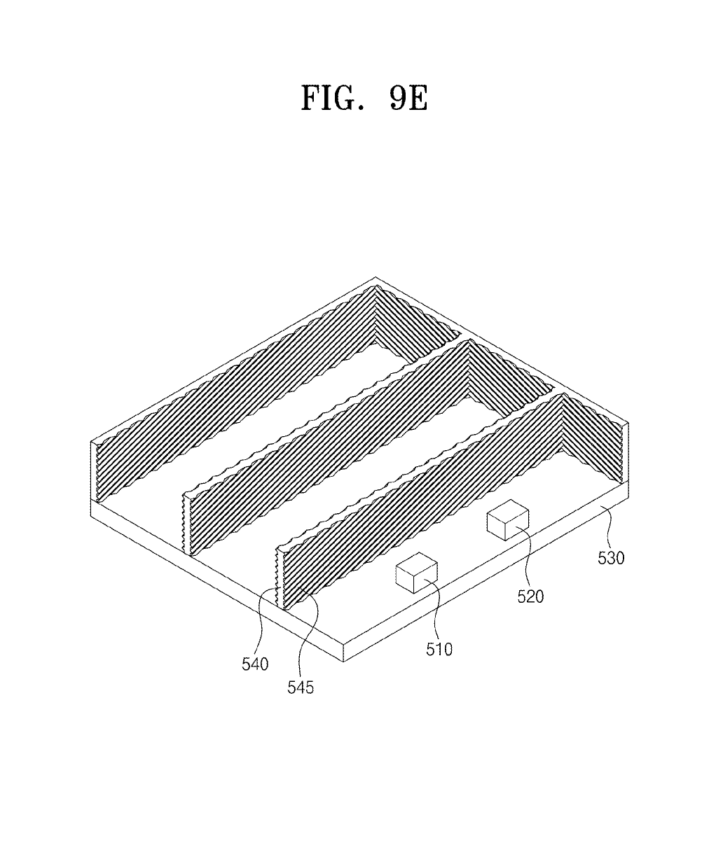

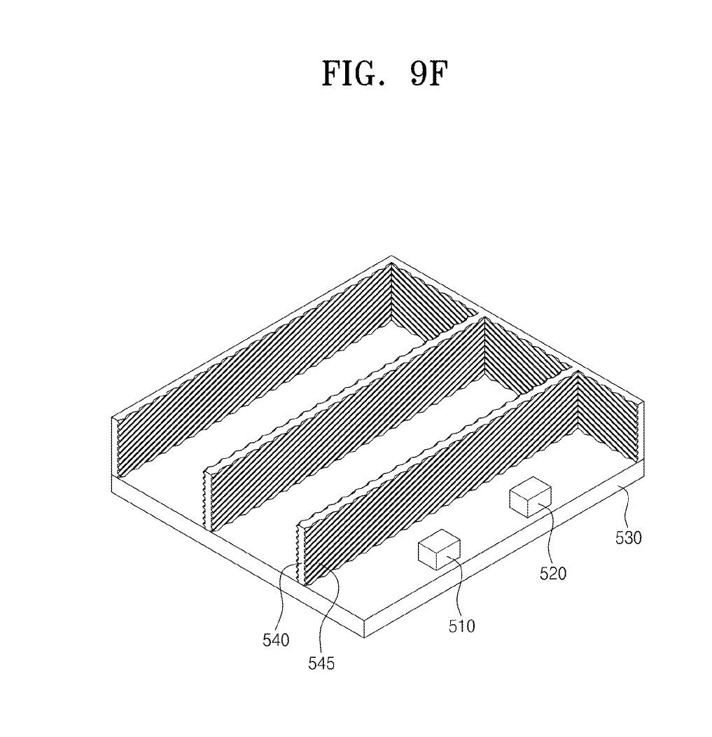

FIGS. 9A through 9F are perspective views illustrating structures of the patterns set in the backlight unit according to embodiments of the present invention.

Referring to FIGS. 9A and 9B, a plurality of the patterns 545 formed on at least one partition 540 confining at least one block region are parallel with the surface of the substrate 530 and also parallel with each other. As shown in FIG. 9A, the patterns 545 formed on the adjacent partitions 540 may be interlinked with each other. As shown in FIG. 9B, the patterns 545 formed in the adjacent partitions 540 may be alternately arranged with respect to each other.

Referring to FIGS. 9C and 9D, the plural patterns 545 formed on the at least one partition 540 are vertical relative to the surface of the substrate 530 and in parallel with each other. As shown in FIG. 9D, the patterns 545 formed in four partitions 540 confining the one block region may all extend in the same direction. In FIG. 9E, the patterns 545 formed on one of the four partitions 540 confining the one block region may extend vertically to the surface of the substrate 530, while the other patterns 545 formed on another one of the four partitions 540 may extend in parallel with the surface of the substrate 530.

Referring to FIGS. 9E and 9F, the plural patterns 545 formed on the at least one partition 540 are arranged to slant with an angle to the surface of the substrate 530, and to be parallel with each other. As shown in FIG. 9E, the patterns 545 formed on the adjacent partitions 540 may be interlinked with each other. Additionally, as shown in FIG. 9F, the adjacent partitions 540 may be alternately arranged with each other.

While FIGS. 9A through 9F exemplarily illustrate the patterns 545 protruding from the surfaces of the partitions 540, the patterns 545 may also be concave in the surfaces of the partitions 540 as shown in FIG. 8B. Additionally, FIGS. 9A through 9F exemplarily illustrate the patterns 545 as wholly formed on the four partitions 540 confining the one block region, it may be permissible to form the patterns 545 on at least one of the partitions 540. Meanwhile, the partitions 540 may be structured with compositions of the patterns shown in FIGS. 9A through 9F.

While light emitted from the light sources 510 and 520 respectively disposed in the block regions is being scattered, the patterns 545 formed on the partitions 540 according to embodiments of the present invention may help the scattered light be reflected to the interiors of the block regions. These structures may thus lessen crosstalk and then improve luminance uniformity in the block regions.

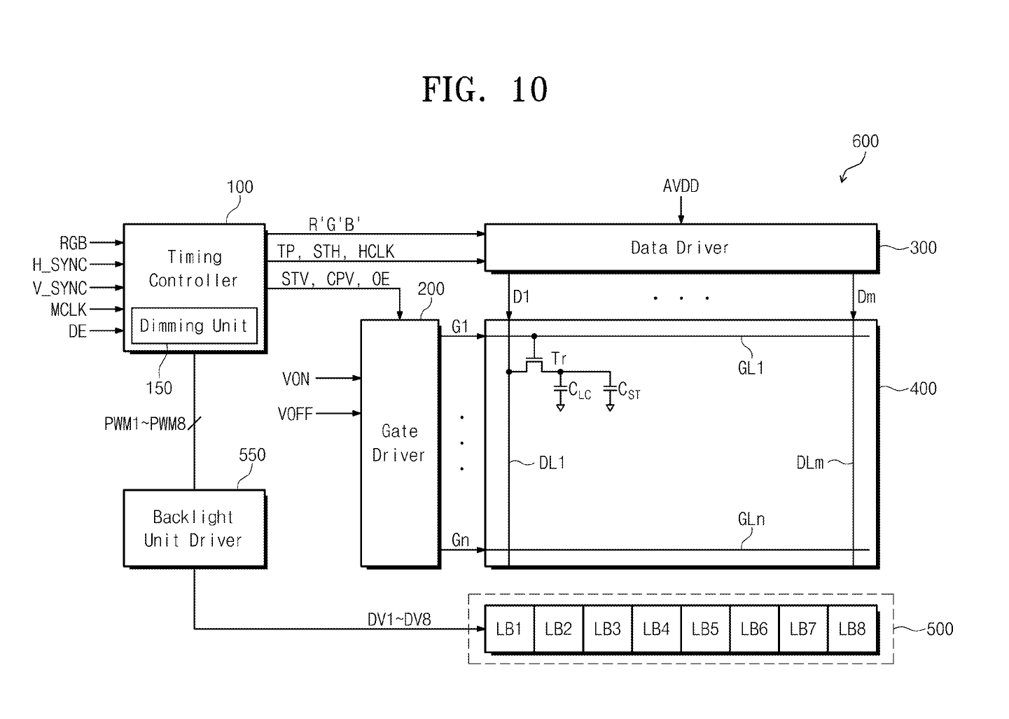

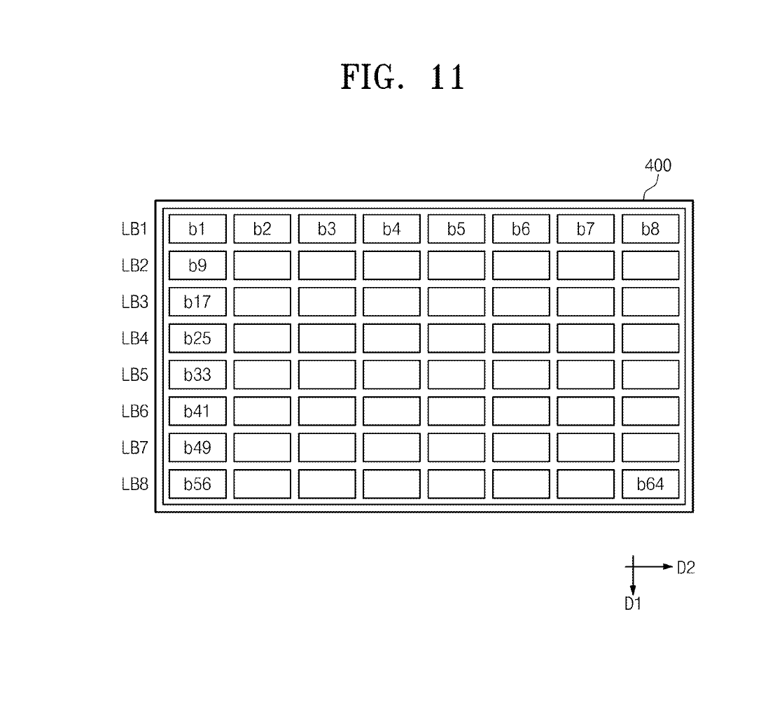

FIG. 10 is a functional block diagram illustrating a display device according to another embodiment of the present invention, and FIG. 11 is a plan view illustrating the correspondence between the backlight unit and the display panel shown in FIG. 10.

Referring to FIG. 10, the display device 600 according to this embodiment includes a display panel 400, a timing controller 100, a gate driver 200, a data driver 300, a backlight unit driver 550, and a backlight unit 500.

The display panel 400 includes a plurality of gate lines GL1˜GLn, a plurality of data lines DL1˜DLm intersecting the gate lines GL1˜GLn, and pixels arranged in areas confined by the gate lines and data liens GL1˜GLn and DL1˜DLm, respectively. For descriptive convenience, FIG. 10 simply shows one pixel as a typical one. Each pixel includes a thin film transistor Tr having gate and source electrodes connected respectively to the gate lines and the data lines corresponding to the gate lines, and a liquid crystal capacitor C_{LC} and a storage capacitor C_{ST} which are connected to the drain electrode of the thin film transistor Tr.

The timing controller 100 receives an image data signal RGB, a horizontal sync signal H_SYNC, a vertical sync signal V_SYNC, a clock signal MCLK, and a data enable signal DE. The timing controller 100 converts the image data signal RGB in data format so as to make it suitable for interface specifications with the data driver, and then outputs the converted image signal R′G′B′ to the data driver 300. Additionally, the timing controller 100 supplies data control signals (e.g. an output start signal TP, a horizontal start signal STH, and a clock signal 100) with the data driver 300, and supplies data control signals (e.g. a vertical start signal STV, a gate clock signal CPV, and an output enable signal OE) to the gate driver 200.

The gate driver 200 receives a gate-on voltage VON and a gate-off voltage VOFF, and then outputs gate signals G1˜Gn, which are charged up to the gate-on voltage VON, in response to the gate control signals STV, CPV and OE. The gate signals G1˜Gn are sequentially applied to the gate lines GL1˜GLn of the display panel 400, scanning the gate lines GL1˜GLn in sequence. Although not shown, the display device 600 may further include a regulator to convert the gate-on voltage VON and the gate-off voltage VOFF and to output the converted voltages.

The data driver 300 may be enabled by receiving an analog drive voltage AVDD, generating a plurality of gray scale voltages by means of gamma voltages supplied from a gamma voltage generator (not shown). The data driver 300 selects correspondents, which accord with the image data R′G′B′. from the gray scale voltages in response to the data control signals TP, STB and HCLK supplied from the timing controller 100, and then applies the selected gray scale voltages as the data signals D1˜Dm to the data lines DL1˜DLm of the display panel 400.

If the gate signals G1˜Gn are sequentially applied to the gate lines GL1˜GLn, the data signals D1˜Dm are applied to the data lines DL1˜DLm in sync with the application of the gate signals G1˜Gn. If a corresponding one of the gate signals is applied to a selected one of the gate lines, the thin film transistor Tr connected to the selected gate line is turned on in response to the corresponding gate signal. If one of the data signals is applied to the data line to which the turned-on thin film transistor Tr is connected, the data signal applied thereto is charged in the liquid crystal capacitor C_{LC} and the storage capacitor C_{ST} after passing through the thin film transistor Tr.

The liquid crystal capacitor C_{LC} operates to adjust its optical transmittance of the liquid crystals in accordance with the charged voltage thereof. The storage capacitor C_{ST} charges itself with the data signal when the thin film transistor Tr is turned on, and applies the charged data signal to the liquid crystal capacitor C_{LC}, maintaining the charge state of the liquid crystal capacitor C_{LC}, when the thin film transistor Tr is turned off. In this manner, the display panel 400 may express images.

The backlight unit 500 includes a plurality of emission blocks LB1˜LB8. In an embodiment, the backlight unit 500 may include N-numbered emission blocks LB1˜LBN (N is a positive integer larger than 1) arranged in the first direction D1. As an example, the backlight unit 500 may include eight emission blocks LB1˜LB8 (hereinafter referred to as ‘first to eighth emission blocks’). Additionally, each of the emission blocks LB1˜LB8 is divided into J-numbered subblocks b1˜bJ (J is a positive integer larger than 1). As an example, each of the emission blocks LB1˜LB8 may include eight subblocks b1˜b8. Accordingly, the backlight unit 500 may be comprised of 64 subblocks b1˜b64 in total.

While FIG. 11 shows the first to eighth subblocks b1˜b8 for each of the first to eight emission blocks LB1˜LB8, the rest 9'th to 64'th emission blocks b9˜b84 are similarly composed like this. The first to eighth subblocks b1˜b8 are connected in parallel with each other, each subblock having at least one light source serially connected.

As illustrated in FIGS. 6 and 7, one light source may be placed in at least one of the subblocks b1˜b8. In embodiments, one subblock includes yellow and blue LEDs. Additionally, in embodiments, the four partitions 540 are formed so as to confine one subblock, and the patterns 545 are formed on each of the partitions 540.

In using a local dimming mode, varying duty ratios or amplitudes of drive signals applied respectively to the subblocks b1˜b8 may be helpful to controlling intensity of light emitted respectively from the subblocks b1˜b8. It is therefore achievable for the subblocks b1˜b8 of the display panel 400 to accept light of different intensity.

The display device operating in the local dimming mode further includes a dimming unit 150 (see FIG. 10) for controlling duty ratios or amplitudes of the drive signals applied respectively to the subblocks b1˜b8. As an example, the dimming unit 150 may be embedded in the timing controller 100. In another example, the dimming unit 150 may be prepared as an additional component out of the timing controller 100.

As aforementioned, since the plural subblocks are independently confined by the partitions 540 formed with the patterns 545 shown in FIGS. 8A-8B and 9A-9F, intensity of light scattering out of each of the subblocks b1˜b8 is lessened so as to restrain crosstalk and color mingling between adjacent ones of the subblocks b1˜b8. Additionally, as light intensity increases in each of the subblocks b1˜b8, it is possible to improve a degree of color saturation and to restrain color breakout.

Simulation Result

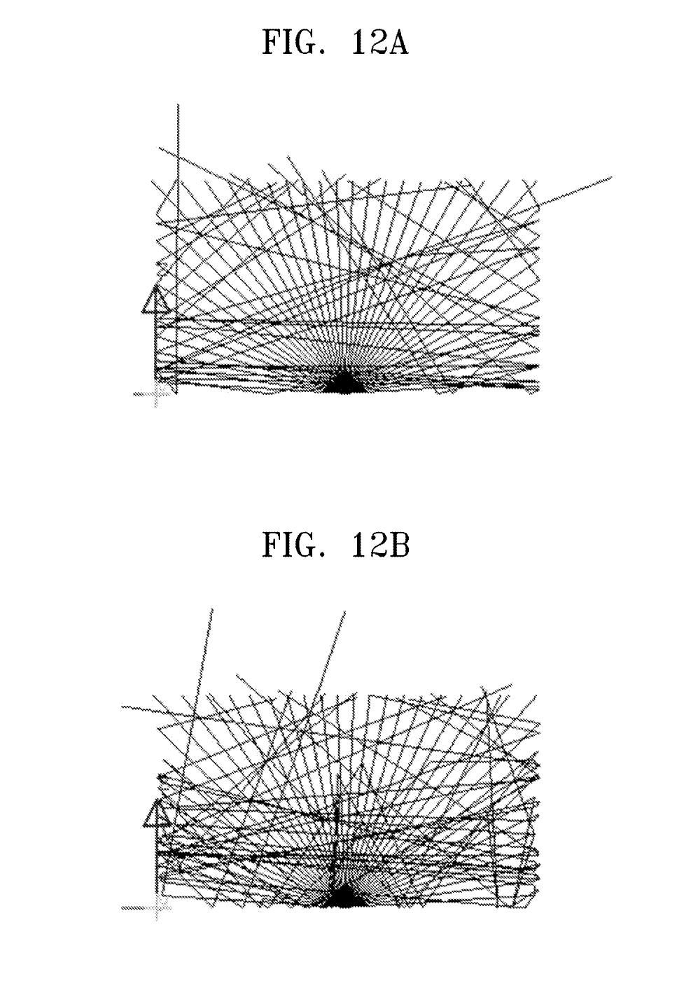

FIG. 12A shows a simulation result for a spectrum of light scattered and reflected in a general backlight unit without patterns in partitions thereof, and FIG. 12B shows a simulation result for a spectrum of light scattered and reflected in a backlight unit with patterns in partitions thereof in accordance with an embodiment of the present invention.

From FIGS. 12A and 12B, it can be seen that light reflected into the blocks in the backlight unit according to an embodiment with patterned partitions is higher in intensity than light reflected into the blocks in the backlight unit without patterned partitions. Therefore, intensity of light scattering into adjacent block regions is reduced so as to lessen crosstalk and color mingling effects. The increasing light intensity in the block regions serves to enhance a degree of color saturation and to lessen color breakout.

Table 1 below comparatively summarizes simulation results about luminance uniformities and crosstalk, being involved in the height of the partitions, between a general backlight unit and an embodied backlight unit according to the present invention.

Referring to Table 1, although the general backlight unit includes partitions confining block regions, these partitions are not accompanied with patterns thereon. The embodied backlight unit may be typically referred to in FIG. 9A.

In Table 1, if the height of the partitions of the general and embodied backlight units is identical to that between the substrate and the diffusion plate, the luminance uniformities appear at about 80% and 90%, respectively. Otherwise, if the height of the partitions of the general and embodied backlight units is 80% of that between the substrate and the diffusion plate, the luminance uniformities appear at about 90% and 93%, respectively. From this result, it can be understood that higher partitions cause a larger effect of dark sites between the block regions separated by the partitions.

Meanwhile, if the height of the partitions of the general and embodied backlight units is identical to that between the substrate and the diffusion plate, the crosstalk appear at about 12%, respectively. Additionally, if the height of the partitions of the general and embodied backlight units is 80% of that between the substrate and the diffusion plate, the crosstalk appear at about 18%, respectively. Also, from Table 1, it can be seen that the backlight unit without partitions has a crosstalk rate of about 40%.

This result means that lower partitions cause crosstalk to be larger as light is further scattered into adjacent block regions.

Consequently, the height of the partitions is a critical factor with respect to luminance uniformity and crosstalk, it being desired to have 80% of the height between the substrate and the diffusion plate. Additionally, it can also be seen that the backlight unit with the patterns formed on the partitions is superior to one without such patterns on the partitions.

As described above, according to the embodiments of the present invention, the patterns formed on the partitions contribute to increasing intensity of light reflected into the block regions, improving a degree of color saturation, lessening crosstalk between adjacent block regions, and then preventing a color mingling effect.

While the present invention has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A backlight unit, comprising:
a substrate having a plurality of block regions;
partitions configured to confine the block regions respectively on the substrate;
patterns extending along a direction on surfaces of the partitions and being parallel with each other; and
light sources disposed respectively in the block regions.

2. The backlight unit according to claim 1, wherein the patterns protrude respectively from the surfaces of the partitions.

3. The backlight unit according to claim 1, wherein the patterns are concave respectively in the surfaces of the partitions.

4. The backlight unit according to claim 1, wherein the patterns have triangular sections with an inner angle of about 30° to about 60°.

5. The backlight unit according to claim 1, wherein the patterns formed on the surface of at least one of the partitions extend in parallel with a surface of the substrate.

6. The backlight unit according to claim 1, wherein the patterns formed on the surface of at least one of the partitions extend substantially vertical to a surface of the substrate.

7. The backlight unit according to claim 1, wherein the patterns formed on the surface of at least one of the partitions extend at a slant relative to a surface of the substrate.

8. The backlight unit according to claim 1, wherein the patterns formed on two adjacent partitions are connected to each other.

9. The backlight unit according to claim 1, wherein the patterns formed on two adjacent partitions are alternately arranged with respect to each other.

10. The backlight unit according to claim 1, wherein the patterns contain a reflective material for reflecting light that is emitted from the light sources.

11. The backlight unit according to claim 1, further comprising a diffusion plate disposed on the partitions, wherein heights of the partitions are about 0.8 times a height extending between the substrate and the diffusion plate.
